(19) United States
(12) Patent Application Publication
(10) Pub. No.: US 2014/0111333 A1
(43) Pub. Date: Apr. 24, 2014

(54) dB

(71) Applicant: Alfred M. Haas, Oakhurst, NJ (US)

(72) Inventor: Alfred M. Haas, Oakhurst, NJ (US)

(21) Appl. No.: 13/749,143

(22) Filed: Jan. 24, 2013

Related U.S. Application Data
(60) Provisional application No. 61/590,186, filed on Jan. 24, 2012.

(51) Int. Cl. G08B 23/00

(52) U.S. Cl. CPC G08B 23/00
USPC 340/539.11

(57) ABSTRACT

The invention disclosed herein relates to methods and means for detecting and communicating and/or signaling the occurrence of events, including but not limited to the satisfaction of one or more conditions. Various embodiments of the methods and means of the invention may be performed by and/or implemented in hardware, in software, by one or more entities, and/or by some combination of hardware, software and/or one or more entities.

### CROSS-REFERENCE TO RELATED APPLICATIONS

Pursuant to 35 USC §119(e) and as set forth in the Application Data Sheet, this utility application claims the benefit of priority from U.S. Provisional Patent Application No. 61/590,186 (“the '186 provisional”) which is incorporated herein in its entirety by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention claims priority from the '186 provisional and expressly incorporates by reference the disclosures contained therein in their entirety, including but not limited to all patents, patent applications, and publications which are incorporated by reference in the '186 provisional and which are incorporated by reference herein in their entirety.

In the context of the instant disclosure, the term “software” is taken in the broadest sense of its ordinary meaning and illustrative examples may comprise, but are not limited to, one or more of the following: realized embodiments of algorithms in any form, code written in whole or in part in any programming, scripting or other language (including, but not limited to, popular languages such as C++, Java, Visual Basic, Python, PHP, HTML, and/or device specific machine or assembly languages, etc. . . . ), programs, mobile and/or other applications (e.g., those for Android and iOS based systems), applets, scripts, operating systems (OS) and components of OS, embedded and other software and instructions, structured data, op codes, commands, executables, firmware, drivers, virtual machines, and/or instruction sets for a system, etc. . . . . Software may operate at many levels including, but not limited to, over a distributed system (e.g., on a cloud computing or mobile network), on a particular device, on a local computer or other machine, embedded in an ASIC or other circuit, and running on top of one or more real or virtual levels, including but not limited to an OS and a hardware level.

In the context of the instant disclosure, the term “hardware” is taken in the broadest sense of its ordinary meaning and illustrative examples may comprise, but are not limited to, one or more of the following: fuel injection electronics, smart and other scales, thermostats, e-readers (e.g. Kindle™ and Nook™), hearing aids, laptop and desktop computers, alarms, smart phones, PDAs, other commercially available electronic devices such as tablet PCs, netbooks, pagers, beepers, cell phones, hearing aids, watches comprising integrated and/or discrete circuits, monitors and displays, televisions, calculators, iPods™ and MP3 players, radios and stereos, speakers, microphones, remote controls, bar code readers, keyboards, cameras, other input devices, data acquisition systems, other physical devices and systems comprising integrated and/or discrete circuits, CPUs, hard drives, flash USB drives, other flash and solid state drives, programmable logic arrays, FPGAs, CPLDs, microcontrollers, digital signal processors, memories, receivers, transmitters, drivers, ADC's (analog-to-digital converters), DAC's (digital-to-analog converters), decoders, multiplexers, comparators, latches, gates, op amps, LNA (low noise amplifiers), PLL (phase locked loops), antennae, coils, radio frequency identification (“RFID”) devices, near-field communication (“NFC”) devices, capacitors, inductors, resistors, transformers, solenoids, other analog circuits and components, other digital circuits and components, other mixed-signal circuits and components, optical circuits, other electromagnetic circuits and components, biological and/or chemical circuits, assemblies of memristors, carbon nanotubes, etc. . . . .

Examples of commercial-off-the-shelf hardware, including but not limited to processing units, displays, microphones, sensors, and speakers may be found on the DigiKey website, “http://www.digikey.com”, the Allied Electronics website, “http://www.alliedelec.com”, and the website “http://www.globalspec.com”. Details pertaining to these sensors may be found in their associated sensor and product data sheets and published specifications.

Some embodiments of the methods and means of the instant invention may employ one or more existing wireless and/or wired communication protocols, or other custom protocols. Illustrative examples of current and historical protocols, programs and standards for digital communication include: the Internet Protocol Suite; e-mail protocols such as POP (Post Office Protocol), SMTP (Simple Mail Transfer Protocol), IMAP (Internet Message Access Protocol), and MAPI (Messaging Application Programming Interface); web browsers such as Safari™, Internet Explorer™ and Firefox™; messaging programs, protocols and standards such as WLM (Windows Live Messenger), MSNP (Microsoft Notification Protocol), AIM (AOL Instant Messenger), ICQ, XMPP (Extensible Messaging and Presence Protocol), IRC (Internet Relay Chat), MIM (Mobile Instant Messaging), SMS (Short Message Service), WAP (Wireless Area Protocol), GPRS (General Packet Radio Service), WLAN (Wireless Local Area Network), Bluetooth™, and Skype™; mobile standards such as GSM (Global System for Wideband Communications), W-CDMA (Wideband Code Division Multiple Access), LTE (Long Term Evolution), and LTE-Advanced, WirelessMAN (Metropolitan Area Networks)-Advanced; NFC (near-field communications), and many others not addressed here. To the extent that documented versions of these protocols, programs and standards are publicly accessible they are incorporated herein by reference. Likewise, some embodiments of the methods and/or means of the instant invention may employ analog and/or mixed-signal methods of communicating data or information. In addition, some embodiments of the invention employ GPS (Global Positioning System) and aGPS (Assisted Global Positioning System) protocols and/or standards.

The following publications and software packages contain information related to the design, development, fabrication, production, assembly, and other aspects of embodiments of the disclosed invention—including, but not limited to, software and hardware such as sensors and transducers, circuits, transmitters, receivers, housings, wearable and other mobile devices, optics, programmable logic elements and chips, custom ASICs, electrical and mechanical switches, electrical and mechanical regulators, etc.: Analysis and Design of Analog Integrated Circuits by Paul R. Gray, Paul J. Hurst, Stephen H. Lewis, Robert G. Meyer, published by John Wiley & Sons, copyright 2001; Digital Principles and Design by Donald D. Givone, published by McGraw Hill copyright 2003; Physics by Paul A. Tipler, published by Worth Publishers, copyright 1976; The New Way Things Work by David Macaulay, published by Houghton Mifflin, copyright 1988; CMOS Circuit Design, Layout and Simulation by R. Jacob Baker, published by the Institute of Electrical and Electronics Engineers, copyright 2005; Microelectronic Circuits by Adel S. Sedra and Kenneth C. Smith, published by Oxford University Press, copyright 1998; Thin Film Technology Handbook by Aicha Elshabini-Riad, Fred D. Barlow III, published by McGraw-Hill, copyright 1998; Field and Wave Electromagnetics by David K. Cheng, published by Addison-Wesley, copyright 1989; VLSI for Wireless Communications by Bosco Leung, published by Prentice Hall, copyright 2002; Complete Wireless Design by Cotter W. Sayre, published by McGraw Hill, copyright 2001; Pattern Classification, Second edition by Richard Duda, Peter Hart and David Stork, published by John Wiley & Sons, Inc., copyright 2001; C++ How to Program, Third edition by H. Dietel & P. Dietel, published by Prentice Hall, copyright 2001; Professional Android 2 Application Development by Roto Meier, published by Wiley Publishing, Inc., copyright 2010; the various versions of the Android SDK; the various versions of the Internet Protocol Suite; the various versions of the iOS SDK; the various versions of the Windows and Windows Mobile SDKs. All publications cited herein are hereby incorporated by reference in their entirety.

The discussion of the background of the invention herein is included to explain the context of the invention. Although each of the patents, patent applications, and publications cited herein are hereby incorporated by reference, neither the discussion of the background nor the incorporation by reference is to be taken as an admission that any aspect, element, embodiment, or feature of the invention was published, known, or part of the common general knowledge as of the priority date of any claims of the invention.

### BRIEF SUMMARY OF THE INVENTION

The invention disclosed herein relates to methods and means for detecting and communicating and/or signaling the occurrence of events, including but not limited to the satisfaction of one or more conditions.

### BRIEF DESCRIPTION OF THE SEVERAL VIEWS OF THE DRAWINGS

FIG. 1 illustrates specific examples of some embodiments of the methods and means of the invention involving the delivery of mail.

FIGS. 2.A.1-2.C.2 illustrate additional specific examples of some embodiments of the methods and means of the invention involving the delivery of mail.

FIGS. 3.A-C illustrate specific examples of some embodiments of the methods and means of the invention involving a doorbell.

FIGS. 4.A and 4.B illustrate specific examples of some embodiments of the methods and means of the invention involving a dispenser.

FIGS. 5.A and 5.B illustrates a specific example of some embodiments of the methods and means of the invention involving a refrigerator.

FIGS. 6.A-C illustrate specific examples of some embodiments of the methods and means of the invention involving various containers that are labeled with tags.

FIG. 7 illustrates a specific example of an embodiment of the means of the instant invention comprising a shelf with an event detector, and also illustrates one example of an embodiment of the methods of the instant invention involving inventory.

### DETAILED DESCRIPTION OF THE INVENTION

The invention disclosed herein relates to methods and means for detecting and communicating and/or signaling the occurrence of events, including but not limited to the satisfaction of one or more conditions.

Illustrative examples of events according to some embodiments of the instant invention may comprise, but are not limited to, the detection of an entity, place and/or thing meeting one or more criteria and/or satisfying one or more conditions; the recognition that an entity, place and/or thing meets one or more criteria and/or satisfies one or more conditions; one or more gestures; one or more physical movements; ringing a doorbell; knocking on a door; asking a question; speaking; touching and/or pressing something; opening and/or closing something; putting something inside an enclosure and/or taking something from an enclosure; putting something on a surface and/or removing something from a surface; an entity crossing a threshold such as a boundary between a vicinity and an area outside that vicinity; the satisfaction of one or more environmental or other conditions; one or more sensors or devices reaching one or more detected threshold values or levels; the occurrence of something; a change in state, etc. . . . . As one specific example, an event may comprise pressing a doorbell; as another specific example, an event might comprise knocking on a door; as another specific example, an event might comprise posing a question, e.g. “Is anybody home?”, or making another detectable sound in a vicinity of a door; as another specific example, an event may comprise one or more entities coming within a proximity of a location for example a door or a mailbox; as another specific example, an event may comprise touching a surface for example a mailbox or a refrigerator; as another specific example, an event may comprise opening an enclosure for example a mailbox; another specific example of an event may comprise placing mail into a mailbox; another specific example of an event may comprise raising and/or lowering a mailbox flag; another specific example of an event may comprise opening a door for example a cabinet and/or a refrigerator door; yet another example of an event may comprise closing a door; another specific example of an event may comprise placing one or more things inside an enclosure for example inside a cabinet, a mailbox, a refrigerator, etc.; another specific example of an event may comprise placing one or more things onto a surface such as a bookshelf and/or refrigerator shelf; another specific example of an event may comprise removing one or more things from a surface such as a bookshelf and/or refrigerator shelf; another specific example of an event may comprise an entity for example a mailman coming within a proximity of a location for example a mailbox; as another specific example an event may comprise a device, sensor and/or system changing state and/or detecting something—e.g. including but not limited to a microphone picking up one or more sounds such as speech or the honking of a horn, a pressure, vibration and/or motion sensor detecting for example a knock on a surface such as a door; an electrical and/or electromagnetic switch being closed, opened, and/or otherwise changing state, a pressure, force, inductive and/or capacitive sensor registering the presence of an entity or thing and/or the movement of an entity and/or a thing, a light sensor being occluded and/or illuminated, a video camera detecting the presence and/or absence of an entity and/or a thing and/or the movement of an entity and/or a thing, etc.; as another specific example, an event may comprise invoking, starting, and/or turning an apparatus, device, and/or system on, and may also comprise disabling, disengaging, shutting down, stopping and/or turning an apparatus, device, and/or system off; as another specific example, an event may comprise changing the state of an apparatus, device, and/or system. It can be readily appreciated that events according to this disclosure are not limited to the illustrative examples provided herein.

Although it is not believed that drawings are necessary for the understanding of the subject matter sought to be patented, for illustrative purposes we have included several figures related to specific examples of embodiments of the disclosed invention.

FIG. 1 shows a cartoon illustration of one specific example of an embodiment of the methods and means of the invention comprising a mailman, (a), in the process of delivering mail, (b), into mailbox, (c), said mailbox having flag (d), and separable event detector, (e), which detects the delivery of the mail and generates and transmits signal, (f), to cell phone, (h), carried by user, (g), which then receives the signal and broadcasts message, (i), “You have received mail!” In this specific example, the event detector comprises a sensing means, a processing unit, a communications module, a power supply, and a housing.

The processing unit represented by but not explicitly drawn in the specific example of an embodiment of an event detector shown in FIG. 1 comprises hardware and/or software for processing signals transduced by the sensing means, for detecting events, and for communicating and/or signaling detected events. In some embodiments of the invention, processing units may comprise microcontrollers. In some embodiments, a processing unit may comprise one or more of a display driver, speaker drivers, input channels, power conditioning circuits, memory, and power supply regulation circuitry. In some embodiments, a processing unit may comprise hardware and/or software for performing other functions including but not limited to processing and transmitting data, processing and transmitting power, controlling and/or operating other hardware and/or software, storing and retrieving data, receiving and decoding voice or other commands, generating signals including but not limited to text, graphics, and speech, as well as for such miscellaneous functions as, e.g. waking and sleeping. In some embodiments, a processing unit comprises custom integrated circuits; in some embodiments the processing unit comprises discrete circuits. In some embodiments, a processing unit comprises a combination of hardware and/or software.

In some embodiments of the invention, a processing unit may comprise a communications module—for example, a transceiver with antenna for communicating with other circuits, components, devices, systems, networks and individuals using electromagnetic (“EM”) waves. In some embodiments, a communications module may be used to transmit and receive data including for example but not limited to a detected event, a sensed signal, digital GPS coordinates, sound samples, images, the identity of a food or beverage (for example, receiving such information from an input device such as a bar code reader, or scanner such as a cell phone bar code reader), nutritional information pertaining to a food and/or beverage, compositional information concerning a substance and/or thing, firmware and software updates, as well as other data (e.g., the time and date, weather conditions, etc. . . . ). In some embodiments, a communications module may comprise an antenna and/or coil for transmitting and/or receiving EM signals. In some embodiments, a communications module may be integrated with a processing unit and/or comprise a separate component that may in some embodiments communicate with the processing unit. In some embodiments, a communications module may communicate wirelessly along one or more wavelengths of the electromagnetic spectrum, including but not limited to, radio waves, IR, and visible light (e.g. via radio transceiver, IR transceiver, other coded and/or modulated light transmissions, etc. . . . ). In some embodiments a communications module may communicate via wires which are not illustrated, for example using one of a variety of USB cables. In addition, in some embodiments a communications module may include speakers and/or microphones and associated circuits for receiving and decoding voice commands and for generating sounds, including but not limited to speech. In some embodiments, a communications module may also be integrated with a power supply—for example by capturing, harvesting and/or storing ambient or transmitted energy from an EM signal. In some embodiments, rechargeable batteries may be charged using energy harvested from EM signals. In some embodiments, a communications module may comprise a transmission means capable of producing vibration and/or low frequency compression waves, for example vibrating motors. In some embodiments, a communications module may comprise a transmission means comprising one or more lights, including but not limited to arrays of lights such as an LCD or LED display. For example, some embodiments comprise OLED (organic light emitting diode) displays like those found in modern cell phones and tablet PCs. However, as used in the context of this disclosure, displays are not intended to be limited to a single or even to existing technology—additional examples of displays include, but are not limited to: liquid crystals, thin film transistors, incandescent lights, fluorescent lights, halogen lights, light emitting diodes, organic light emitting diodes, lasers, fiber optics, color changing polymers, pigmented fluids, solutions and mixtures, functionalized micro-beads, and e-inks.

It should be noted that the cartoon depictions of wireless signals in the Figures are not intended to limit the disclosure or the invention in any way; in various embodiments of the invention communications, transmissions and/or other signals may be substantially uni-directional (e.g. collimated laser light), bi-directional, one-way, two-way, multi-way, and any other direction or way EM and/or sound waves and/or other signals can travel, depending on the communications means, and limited only by the laws of physics and the transmission media.

Illustrative examples of a power supply include, but are not limited to, a battery holder, batteries (both rechargeable and regular), solar cells and associated charging circuitry, a plug for receiving wall power with or without associated circuitry (such as electrical transformers, rectifiers, voltage regulators, capacitors, etc.), an inductive power receiver element (such as a coil and circuitry to receive inductively coupled power), an electromechanical generator (think self-winding watch), a thermal and/or electromechanical generator (think MEMS/NEMS generators), and any other suitable source of power.

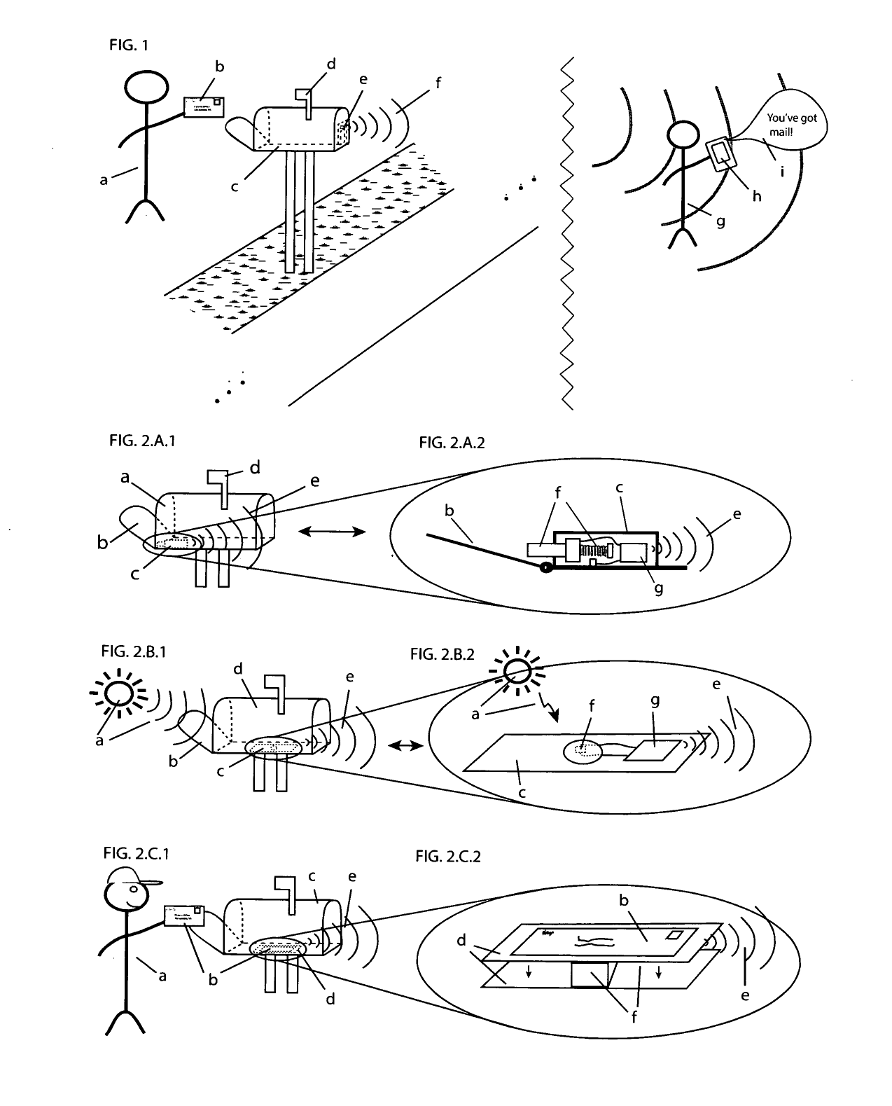

FIG. 2 illustrates specific examples of some embodiments of the methods and means of the invention. FIG. 2.A.1 schematically illustrates a mailbox, (a), having hinged door, (b), flag, (d), and integrated event detector, (c), which is broadcasting signal, (e), generated by a communications module of processing unit, (g), which detected an event when sensing means switch, (f), changed states (closed to open) when door, (b), was opened. FIG. 2.A.2 is a blown-up cutaway side-view figure of event detector, (c), and door, (b), shown in FIG. 2.A.1. FIG. 2.B.1 schematically illustrates a mailbox, (d), having hinged door, (b), and integrated event detector, (c), which is broadcasting signal, (e), said signal being generated by the communications module of processing unit, (g), which detected an event when the intensity of light, (a), radiating through the open mailbox door and onto light sensing means, (f), rose above a programmed threshold. FIG. 2.B.2 shows a blown-up cutaway schematic view of event detector, (c), and light, (a), shown in FIG. 2.B.1. FIG. 2.C.1 schematically illustrates mailman, (a), depositing mail, (b), into mailbox, (c), having removable event detector, (d), which is broadcasting signal, (e), generated by the communications module of a processing unit comprising event detector, (d), which detected an event when force sensing means, (f), measured a change in mass resulting from mail, (b), being placed atop force sensing means, (f). FIG. 2.C.2 shows a blownup cutaway schematic view of event detector, (d), and mail, (b), shown in FIG. 2.C.1.

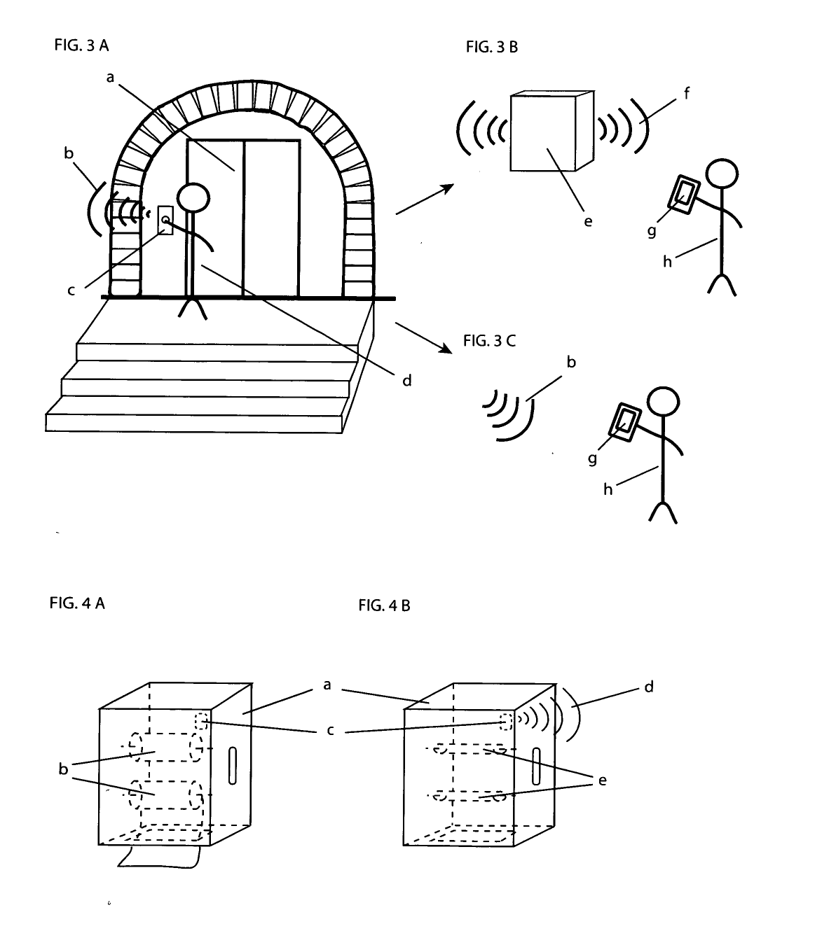

FIG. 3.A shows a specific example of an embodiment of the methods and means of the invention wherein an individual, (d), proximate to door, (a), rings doorbell, (c), which generates a signal, (b), comprising, without loss of generality, a wireless transmission. FIG. 3.B illustrates a specific example of an embodiment of the methods and means of the invention involving a separate event detector, (e), comprising a sound sensing means and processing unit which together detect the sound generated by doorbell chimes (not explicitly drawn), and further comprising a communication module that generates and transmits a wireless signal, (f), that is received by cell phone, (g), which sounds an alert corresponding with the detected event and flashes a message on screen for user, (h). FIG. 3.C illustrates an example of an embodiment where doorbell, (c), and cell phone, (g), together comprise an event detector, where doorbell, (c), comprises a processing unit and a communications module that transmits signal, (b), over a network to cell phone, (g), which communicates and/or signals the detected event to user, (h), via text message.

FIG. 4 depicts a specific example of an embodiment of the invention involving a dispenser. FIG. 4.A shows a full paper towel dispenser, (a), having rolls of paper towels, (b), and integrated event detector, (c). FIG. 4.B shows the same paper towel dispenser, except empty, as evinced by empty rolls, (e), wherein event detector, (c), detects a low paper towel condition and wirelessly transmits signal, (d), to convey this condition to the maintenance staff. In some embodiments quantity of an item such as paper towels may be detected by weight and/or pressure sensing means; in some embodiments low stock of an item such as paper towels may be detected using optical means; in some embodiments a low stock condition may be detected using a counter to assess the quantity of an item dispensed (e.g. by counting the number of revolutions of one or more towel dispensers, by optically measuring dispensed items, or by other means). In some embodiments, other sensing means may be used to detect the quantity of an item.

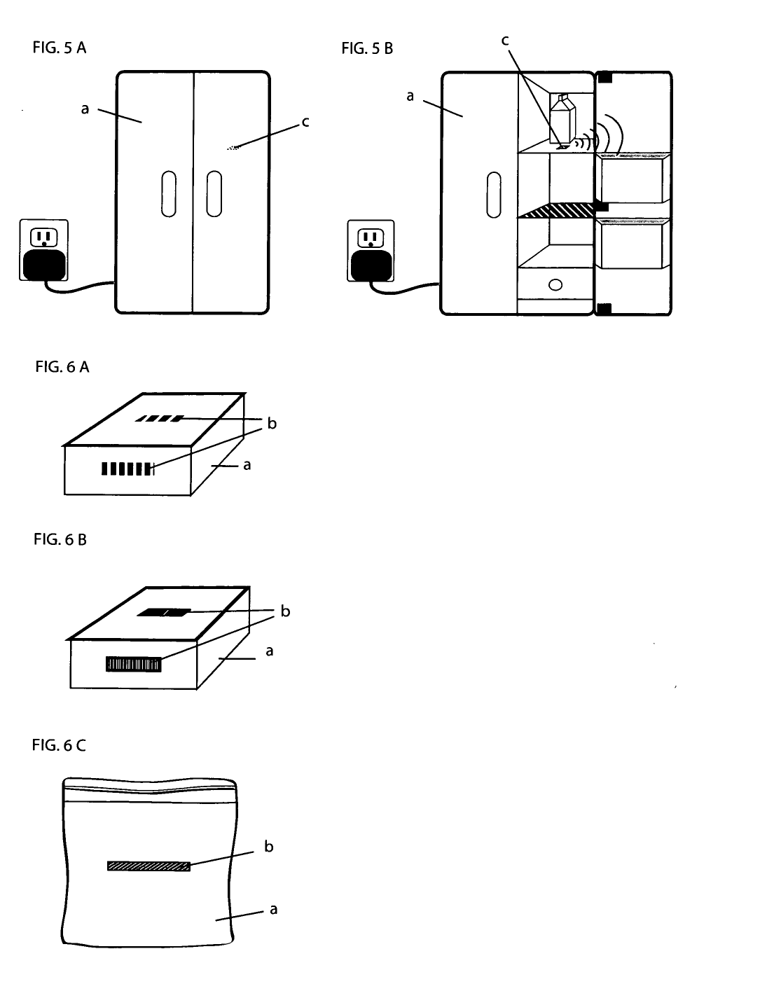

In FIG. 5.A, a refrigerator, (a), comprising a separable event detector, (c), according to an embodiment of the instant invention is shown. In FIG. 5.B the event detector, (c), determines that the refrigerator door has been opened and commences to read a tag on a labeled container—in this illustration, a milk carton—to identify the contents of the container and then communicates wirelessly over a network with a remote server to ascertain data pertaining to the contents of the identified container, and either simultaneously or at different times, repeats the process with other labeled items in the refrigerator, then communicates wirelessly with a user's cell phone to provide an inventory of food in the refrigerator and the nutritional composition of each labeled item contained therein. In some embodiment, tags may comprise one or more of paper, ink, writing, embossed or etched markings including text, shapes, codes, RFID and/or NFC devices, transceivers, displays including one or more lights, chemicals, and any other detectable labels. In some embodiments, an event detector may read a tag using RF communications; in some embodiments an event detector may employ other sensing means to read a tag. In some embodiments, an event detector may use other methods besides tags to ascertain the contents of a refrigerator; for example optical sensing means such as a camera might be used in conjunction with a classifier to identify foods and beverages without tags. In some embodiments of the invention, an event detector may record, log and/or count each time a refrigerator door and/or other container is opened and/or closed. In some embodiments of the invention, an event counter may record, log and/or count each time an item is placed in and/or removed from a refrigerator.

In some embodiments of the invention, an event detector according to the instant invention may comprise a real-world “hit” counter, which may communicate and/or signal one or more counts corresponding with the occurrence of one or more detected events, e.g. a door being opened. In some embodiments, a hit counter event detector may transmit e-mails, text messages or other electronic communiqués over a network such as the internet and/or to a device capable of accessing a network, for example including but not limited to a cell phone, a tablet PC, and/or other hardware and/or software device.

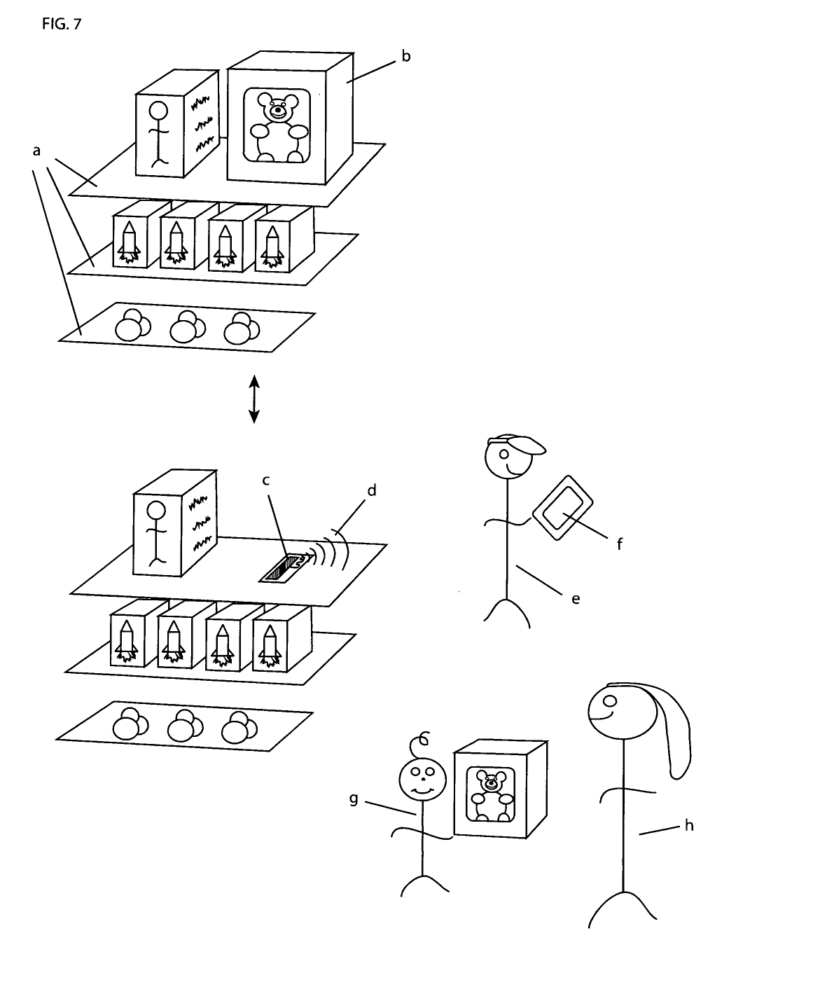

FIG. 6 illustrates various containers that are labeled with tags according to specific examples of some embodiments of the invention. In FIG. 6.A, plastic container, (a), has bar code tags, (b). In some embodiments bar code tags comprise ink, in others, bar code tags may be etched and/or embossed onto containers. In some embodiments, bar code tags may be magnetic. FIG. 6.B shows plastic container, (a), having tags, (b). In some embodiments, tags may be RFID and/or NFC devices. In some embodiments tags may comprise transmitters and/or receivers. In some embodiments tags may be programmable, re writeable, and/or erasable. In some embodiments, tags may be removable. In some embodiments tags may comprise adhesives. FIG. 6.0 illustrates a plastic bag, (a), having tag, (b). In some embodiments, tags may be conformal, flexible, malleable, moveable, pliable, plastic, rubbery, and/or stretchable. In some embodiments, tags may be water proof, water resistant, permeable, and/or semipermeable.

FIG. 7 illustrates a specific example of an embodiment of the invention wherein shelves, (a), supporting inventory, (b), detect when child, (g), with mother, (h), removes toy, (b), from the shelf comprising integrated event detector, (c), that broadcasts signal, (d), to the tablet PC (f), of stock manager, (e). In this particular illustration, toy (b) is labeled with an NFC tag whose absence is detected by event detector, (c).

It should be noted that the figures and examples they represent are provided for illustrative purposes only and are not intended to limit the scope of the instant invention.

Although the foregoing invention has been described in some detail by way of illustration and example for purposes of clarity and understanding, it will be readily apparent to those of ordinary skill in the art in light of the teachings of this invention that certain changes and modifications may be made thereto without departing from the spirit and purview of this application or scope of the appended claims. All publications, patents, and patent applications cited herein are hereby incorporated by reference in their entirety.

I claim:

1. A means comprising hardware for detecting and communicating and/or signaling the occurrence of events, including but not limited to the satisfaction of one or more conditions.

2. The means of claim 1 wherein the hardware comprises one or more of a cell phone, a tablet computer, a worn device comprising a microprocessor, and a personal digital assistant.

3. A method for detecting and communicating and/or signaling the occurrence of events, including but not limited to the satisfaction of one or more conditions.

4. The method of claim 3 wherein one or more steps of the method involves the use of hardware comprising one or more of a cell phone, a tablet computer, a worn device comprising a microprocessor, and a personal digital assistant.
